(19) United States
(12) Patent Application Publication
(10) Pub. No.: US 2002/0149623 A1
(43) Pub. Date: Oct. 17, 2002

(54) State and data driven dynamic menu and toolbar architecture

(76) Inventors: Alan West, Edinburgh (GB); Ken Milne, Glasgow (GB)

Correspondence Address: Cary S. Kappel, DAVIDSON, DAVISON & KAPPEL, LLC, 14th Floor, 485 Seventh Avenue, New York, NY, 10018, US

(21) Appl. No.: 09/770,320

(22) Filed: Jan. 26, 2001

(51) Int. Cl. G06F 3/14

(52) U.S. Cl. 345/765; 345/810

(57) ABSTRACT

A system and method is provided for generating menu/toolbar entities on a graphical user interface. An application is provided which can be displayed in a frame of a graphical user interface and which has a set of menu/toolbar entities. At any given time, the application can be in one of a plurality of application states. Information indicative of an application state characteristic for each application state of the application is contained in a data file, and each application state characteristic defines a display characteristic of at least one of the set of menu/toolbar entities. The system generates a displayed set of menu/toolbar entities on the graphical user interface based upon the application state characteristic of a current one of the application states of the application.

This application is related to U.S. application Ser. No. ______ filed Jan. 26, 2001, entitled Policy Based Approach to Menus and Toolbars [attorney docket 218.1004], the entire disclosure of which is hereby incorporated by reference.

### FIELD OF THE INVENTION

The present invention relates generally to the field of computer programs. Specifically, the present invention relates to menu and toolbar architectures.

### BACKGROUND OF THE INVENTION

Software applications often make use of menus and toolbars to allow users to select different functions and options in a graphical user interface. Generally, menu items and tool items, which are associated with the functions and options, make up the menu or toolbar. Menus and toolbars function both in MDI environments and SDI environments. In an MDI (Multiple Document Interface) environment, a single parent window contains any number of child windows. The menus and/or toolbars associated with each child window are displayed on a frame of the parent window. In an SDI (Single Document Interface) environment, new windows are spawned for each user visible process or view, and a new menu and/or toolbar is placed on the frame of each new window.

In an MDI environment, the menus and toolbars, with their associated menu and tool bar items need to be modified as different applications are opened in the child windows, as these applications gain or lose focus, and as the user interacts with the application, so that an appropriate set of menus, toolbars, and other options are available to the user. In a more general sense, the set of options available to the user changes as a different type of data object is selected by the user in one of the windows. The enabling, disabling, and changing of the menu and toolbar options (and other input devices such as check boxes, etc.) are conventionally implemented by source level programming.

### SUMMARY OF THE INVENTION

In accordance with the present invention, a system and method is provided for altering menu/toolbar entities (or other graphical input entities) on a graphical user interface. Information indicative of a corresponding set of graphical input entites for each of a plurality of system conditions is maintained in a data file. A displayed set of graphical input entities is generated based upon a current system condition. In this regard, the term system condition is meant, for purposes of the present invention, to encompass application states, application creation and destruction, and changes in focus of applications displayed on the graphical user interface.

In accordance with a first embodiment of the present invention, a system and method is provided for generating menu/toolbar entities on a graphical user interface having a parent frame for displaying menu/toolbar entities and a plurality of child frames. A set of applications is provided which can be displayed in the plurality of child frames. Each application has a corresponding set of menu/toolbar entities and information indicative of a policy for each menu/toolbar entity of each application is contained in a data file. Preferably, each application has a corresponding data file. A displayed set of menu/toolbar entities on the graphical user interface is generated based upon the policies of the menu/toolbar entities for a currently focused one of the applications.

In the context of the present invention, the term “menu/toolbar entity” is meant to encompass tool bars with their associated tool bar items (e.g., buttons), as well as menu bars with their associated pull-down menus (hereinafter “menu”), each in turn having respective menu items. Moreover, in the context of the present invention, an application is in focus (“currently focused application”) when it is in the active window (i.e., the window with the cursor) and the terms gaining focus, and losing focus, and the like, refer to the transition of an application in and out of focus. In the context of the present invention, the term “input entity” is meant to more broadly encompass any graphical entity that transforms a user's manual selection into the invocation of an action in the application. Examples of input entities include men/toolbar entities, as well as checkbox elements, radio elements, button elements, select elements, and the like.

The policies of the menu/toolbar entities control the manner in which these entities are incorporated into the graphical user interface when the application gains focus. For example, a policy might indicate that the entity is to be added to a menu or a tool bar, that it is to replace another entity in a menu or a tool bar that corresponds to an application losing focus, or that the entity is to have no affect whatsoever on the menu or the tool bar.

In accordance with a second embodiment of the present invention, a system and method is provided for altering the input entities displayed for a currently focused application based upon a current state of the application. It should be noted that this embodiment is applicable to any graphical user interface which displays menu/toolbar entities. For example, this embodiment applies equally to MDI-type interfaces (interfaces with a parent frame for displaying a set of menu/toolbar entities and a plurality of child frames for displaying applications) and SDI-type interfaces (interfaces in which each frame has a corresponding set of menu/toolbar entities). As explained above, the input entities may be menu/toolbar entities, or any other graphical entity that transforms a user's manual selection into the invocation of an action in the application.

In accordance with one aspect of this embodiment, a system and method is provided for generating input entities on a graphical user interface. An application is provided which can be displayed in a frame of a graphical user interface and which has a set of input entities. At any given time, the application can be in one of a plurality of application states. Information indicative of an application state characteristic for each application state of the application is contained in a data file, and each application state characteristic defines a display characteristic of at least one of the set of input entities. The system generates a displayed set of input entities on the graphical user interface based upon the application state characteristic of a current one of the application states of the application. In accordance with other aspects of this embodiment, the set of input entities comprises a set of menu/toolbar entities.

In accordance with another aspect of this embodiment, a system and method is provided for generating menu/toolbar entities on a graphical user interface having a parent frame for displaying menu/toolbar items and a plurality of child frames. A set of applications is provided which can be displayed in the plurality of child frames and each application has a corresponding set of menu/toolbar entities. In addition, each application is in one of a respective plurality of application states at any given time. Information indicative of an application state characteristic for each application state of each application is contained in a data file, and each application state characteristic defines a display characteristic of at least one of the set of menu/toolbar entities. The system generates a displayed set of menu/toolbar entities on the graphical user interface based upon the application state characteristic of a current one of the application states of a currently focused one of the applications. Preferably, each application has a corresponding data file for holding its application state characteristics.

Preferably, an application can have a plurality of states, and each state, in turn, can have state-parts and sub-states. A sub-state is a further definition of the state which is exclusive (e.g., an application can only be in one sub-state of a state at any given time). However, a sub-state can, itself, have a further sub-state. A state part is a further definition of the state which is non-exclusive (e.g., the application can be in multiple state parts of a state at any given time). The current state, sub-state, and/or state-part of an application is set in the underlying source code of the application in a conventional manner. For example, the code “Static final String OnceSelectedState= “OneSelected”; statesD.setState(OneSelectedState)” or the like could be used to set the state of an application to a OneSelected state. For each state, sub-state, or state part of an application, the data file contains one or more application state characteristics which govern the display of some or all of the input entities when the application is in the corresponding state, sub-state, or state part. For example, the application state characteristics could determine whether a given menu/toolbar entity is active (e.g., selectable) or inactive (e.g. “greyed” out). In a particularly preferred embodiment, the data file includes text in a format of:

<state specification><property>=<item,item,item . . . > to specify an application state characteristic, wherein a state specification field identifies the application state, the item field identifies the menu/toolbar entities which are modified, and the property field indicates whether the application state enables or disables the menu/toolbar entities. However, the state changes described above could be used to set any attribute of any input entity. For example, it could be used to add, alter or remove buttons, menus, or toolbars:

Toolbars[State1]=toolbar1 toolbar2

Toolbars[State2]=toolbar1

FileMenu[State3]=edit copy save

FileMenu[State4]=edit copy saveAs

ToolBarButton1.ToolTip=A tooltip

ToolbarButton1]State3+StatePart1].ToolTip =A different tooltip

In accordance with yet another aspect of this embodiment, a system and method is provided configuring a plurality of menu/toolbar entities for an application which comprises the steps of: selecting a plurality of states for an application, the application having associated therewith a plurality of menu/toolbar entities for displaying on a graphical user interface; selecting a state characteristic for each state, the state characteristic defining characteristics of a plurality of menu/toolbar entities of the application based on the state, information defining the state characteristics being stored in a data file; entering the application into a current one of the plurality of states; and applying the state characteristic of the current state of the application to the plurality of menu/toolbar entities displayed on a graphical user interface, based upon the information in the data file. As explained above, the states of an application are preferably set in the source code of the application, whereas the state characteristics are defined in the data file. Then, as the application enters various states (or sub-states, or state-parts), the corresponding state characteristics are applied.

In accordance with further aspects of the second embodiment, a stack is used to keep track of the current state, state parts, and sub-states. For example, when a new state is to be entered, all prior states and sub-states (with any associated state parts) are popped off of the stack and the new state is pushed onto the stack. If a state part is entered, it is added to the current state or sub-state on the stack. In this regard, state parts can be considered additional attributes of a state (or sub-state), and the stack viewed as a stack of states and sub-states. If the state part is removed from the current state on the stack, the state of the application is defined by the current state on the stack (with any remaining state parts for the state).

In accordance with a third embodiment of the present invention, the policy based menu/toolbar system of the first embodiment is combined with the state-driven menu/toolbar system of the second embodiment. In accordance with this embodiment, a system and method for generating menu/toolbar entities on a graphical user interface having a parent frame for displaying menu/toolbar items and a plurality of child frames is provided. A set of applications is provided which can be displayed in the plurality of child frames and each application has a corresponding set of menu/toolbar entities. Information indicative of a policy for each menu/toolbar entity of each application is contained in a data file. In addition, each application can be in one of a respective plurality of application states at any given time, and information indicative of an application state characteristic for each application state of each application is also contained in the data file. Each application state characteristic, in turn, defines a display characteristic of at least one of the set of menu/toolbar entities. The system generates a displayed set of menu/toolbar entities on the graphical user interface based upon the policies of the menu/toolbar entities for a currently focused one of the applications and upon the application state characteristic of a current one of the application states of the currently focused application.

Through the use of data file(s) to specify the policies and/or state characteristics for the applications, the present invention provides a graphical user interface which can easily be reconfigured by developers and/or users without the need to modify and compile source code.

### BRIEF DESCRIPTION OF THE DRAWINGS

FIG. 1 shows an exemplary set of a menu bars and tool bars.

FIG. 2 shows a flow chart for a preferred system in accordance with the present invention.

FIG. 3 is an illustrative representation of the policies that can be defined for the overall menu bar (in situations in which there is more than one), each menu in the menu bar, each item on a menu bar, the overall toolbar (in situations in which there is more than one), and for each item on a toolbar.

FIG. 4 shows the policies that can be defined for items.

FIG. 5(a) is an illustrative representation of a menu configuration showing the currently displayed menus.

FIG. 5(b) is an illustrative representation of a menu configuration for an application.

FIG. 5(c) is an illustrative representation of the menu bar after the application gains focus.

FIG. 5(d) is an illustrative representation of the menu bar after the application loses focus.

FIG. 6 shows a flow chart of a method by which the application state characteristics can be implemented in the state/data driven approach to configuring menus and toolbars;

FIG. 7 is an exemplary representation of a properties file for a view in a Tornado-type development system, which uses an MDI environment for menus and toolbars;

FIG. 8(a) is an illustrative representation of a menu in the MDI environment in the oneselected state.

FIG. 8(b) is an illustrative representation of a menu in the MDI environment in the manyselected state.

FIG. 8(c) is illustrative representation of a menu in the MDI environment in the normalmode state.

FIG. 9(a) is an illustrative representation of a menu in the MDI environment in the base state;

FIG. 9(b) is an illustrative representation of the menu after the active state is pushed to the stack;

FIG. 9(c) is an illustrative representation of the menu after the active state has been popped from the stack, and the NormalMode state and the SysModeNotAllowed state part are pushed to the stack;

FIG. 9(d) is an illustrative representation of the menu after the NormalMode state and the SysModeNotAllowed state part have been popped from the stack, and the SystemMode state and the SysModeOnly state part are pushed to the stack; and

FIG. 9(e) is an illustrative representation of the menu bar after the Notaskselected state part is pushed to the stack.

### DETAILED DESCRIPTION OF THE PREFERRED EMBODIMENTS

The preferred embodiment of the present invention relates to a system for managing tool bars and menu bars in an application environment wherein a plurality of views are controlled via a single menu bar and tool bar. In this context, a view refers to a display window, or display pane, which is displayed on a computer monitor or other display device. An example of such a system would be a MDI (multiple document interface) application running in a Windows 95/NT environment. For purposes of the present invention, each view will be referred to as an “application.” Moreover, although multiple views might be generated by a single overall application, in accordance with the preferred embodiment of the present invention, each view is generated by an independently executable application. In accordance with a first embodiment of the present invention, a system is provided for designating the manner in which menu bars and tool bars are generated as a view is created (i.e. opened), loses focus, gains focus, or is destroyed (i.e. closed). In accordance with a second embodiment of the present invention, a system is provided for designating the manner in which menu bars and tool bars are generated as a currently focused application changes its state in response, for example, to user keystrokes, or messages from other applications or the operating system. In accordance with a further embodiment of the present invention, the first and second embodiments are combined to provide a system which designates the manner in which menu bars and tool bars are generated as a view is created, loses focus, gains focus, is destroyed (i.e. closed), or changes state.

In the context of the present invention, a menu bar or tool bar refer to a set of persistent visual elements which appear on or about a parent pane of a window comprised of a parent frame and a plurality of child panes, and which set of elements can act on any one of the child pane when that child pane is in focus. In general, the term menu bar refers to a set of “pull-down” menus while the term tool bar refers to a set of “buttons”. Typical menu bar menus include “File”, “Edit”, “View”, “Insert”, “Format”, “Tools”, “Window”, and “Help”, each having a set of menu items. Typically, an MDI includes a single menu bar with a set of menus, which, in turn, include menu items. However, it is also possible to have multiple menu bars, each having their own respective sets of menus and menu items. Typical tool bar button items include create new file, open file, save file, cut, copy, paste, print, etc. In the context of the present invention, the term “menu” is used to refer to the individual menu bar menus, and the term “item” is used to collectively refer to menu bar items and tool bar button items. Finally, the term menu/tool bar entity is used to generically refer to menu bars, tool bars, menus, menu items, and tool bar items.

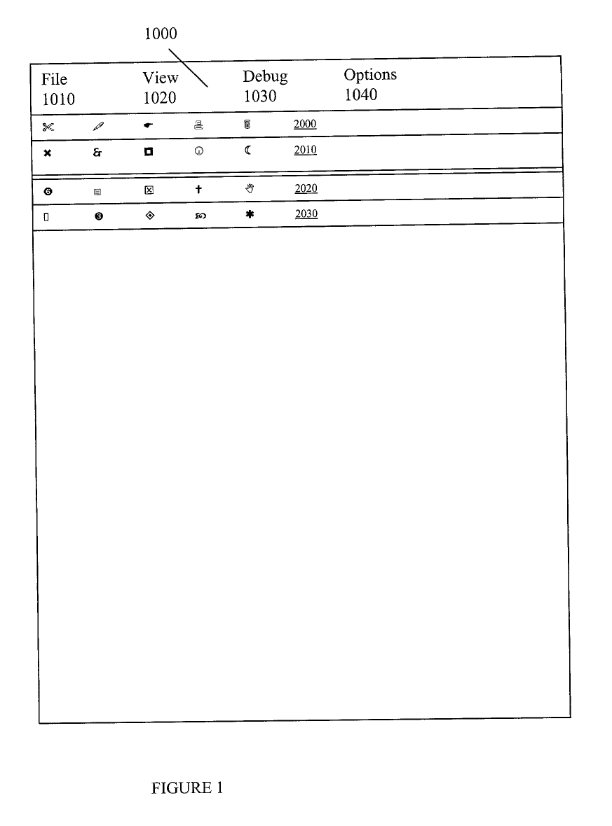

FIG. 1 shows an exemplary set of a menu bars and tool bars. In accordance with this embodiment, a system provides a MDI with a menu bar 1000 includes a File pull down menu 1010, a View pull down menu 1020, a Debug pull down menu 1030, and an Options pull down menu 1040. The MDI also includes a standard toolbar 2000, a task toolbar 2010, a domtoolbar 2020, and a view toolbar 2030. Preferably, at the user's option, one, some, all, or none of the menu bar 1000, and the toolbars 2000, 2010, 2020, and 2030 can be displayed at various locations on the parent frame of the MDI. It should be noted that the icons on the toolbars 2000-2030 are of an arbitrary nature, and are simply intended to show that the elements of a toolbar, as contrasted to a menu bar, are clickable buttons or some other form of user selectable item.

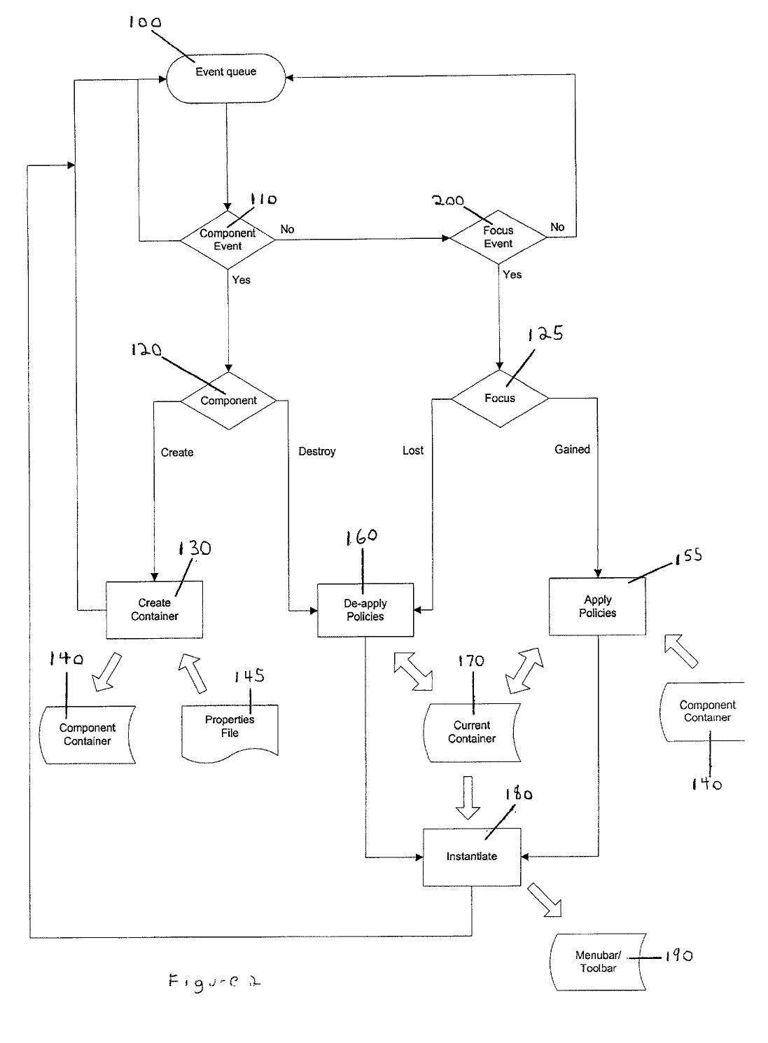

FIG. 2 shows a flow chart for a preferred system in accordance with the present invention. At step 100, the system monitors a current event on its event queue, and determines whether the current event, e.g., a user action or a message sent from another processing device is an application event (step 110). In this regard, an application event can be one of an application create event (i.e., the view is opened) or an application destroy event (i.e., the view is closed). If the event is not an application event, the system proceeds, at step 200, to determine whether or not the event is a focus event. A focus event can be one of a gain focus event (i.e., the view gains focus) or a lost focus event (i.e., the view loses focus). If the event is neither an application event or a focus event, control is returned to step 100. Preferably, the application that the event refers to is defined as a Java component.

If the event is an application event (step 110), the method determines if the application event is a create event or a destroy event (step 120). If it is create event (i.e. a previously closed application is invoked to create a view), a create container function is invoked (step 130). The create container function reads one or more policies from a properties file 145, and then integrates the policies into a container for the application (hereinafter an application container 140). Although a variety of programming techniques can be used to create the container, the container preferably conforms to the Java definition of a container. The method then returns to the event queue 100. If the application event is a destroy event, the application is destroyed (i.e. the view is closed), the policies for the application are de-applied (step 160), and a new menu/tool bar is created (or instantiated) based upon the policies of the active applications (i.e. those corresponding to the remaining open views, taking into account which view is in focus). After the instantiation, the method returns control to the event queue 100.

If the event is a focus event (step 200), the method proceeds to determine, in step 125 if the focus is lost or gained by the application. If the focus is lost, the method de-applies the policies for the application that lost the focus (step 160), and a new menu/tool bar is created in instantiation step 180, wherein a new menu/tool bar 190 is generated based upon the policies of the active applications, taking into account the change in focus. However, if focus is gained, the method applies the policies 155 of the container 140 of the application that gained focus, the container 140 of the application that gained focus is combined with the current container 170, and the method moves to the instantiation step 180, wherein a new menu/tool bar 190 is generated based upon the policies of the active applications, taking into account the change in focus.

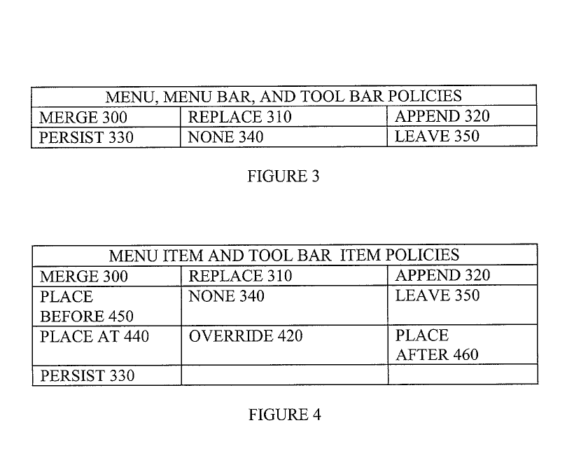

FIG. 3 is an illustrative representation of the policies that can be defined for the overall menu bar (in situations in which there is more than one), each menu in the menu bar, each item on a menu bar, the overall toolbar (in situations in which there is more than one), and for each item on a toolbar.

In this regard, each menu bar, menu, menu item, tool bar and toolbar item (collectively menu/tool bar entities”) includes an identifier which is used to associate similar menu/toolbar entities. Typically, the name of the menu, menu item, and toolbar item is simply the text name of the menu or item (e.g., File, paste, cut, etc.). As the displayed names of menu bars and toolbars tend to be more unique to the respective application view, the identifier of menu bars or toolbars are preferably selected so that similar menu bars or tool bars from various application views will have the same identifier. Using standard string matching techniques, similar identifiers could also be associated so that, for example, the identifier “undo” could be matched with the identifier “undo(last change).” In any event, the policies that can be defined are merge 300, replace 310, append 320, persist 330, none 340, and leave 350.

If the merge 300 policy defines a menu/toolbar entity in an application gaining focus, and a menu/toolbar entity with the same identifier (e.g., a menu name or icon) exists in the current menu bar or tool set, both menus or tool bars are merged together pursuant to the policies defined in the items of the respective menu or the respective toolbar (See FIG. 3). In this regard, if matching menu bars exist, a composite menu bar is generated which includes all of the underlying menus and menu items. If matching tool bars exist, a composite tool bar is generated which includes all of the underlying tool bar items. In both cases, the manner in which the underlying menus, menu items, and tool bar items are combined is governed by the policies listed for these respective menus, menu items, and tool bar items.

If the replace 310 policy is defined for a menu/toolbar entity of the menu bar or tool bar set, an application gaining focus, and the same identifier exists for a menu/toolbar entity in the current menu bar or toolbar set, the menu/toolbar entity having that identifier in the current menu bar or tool set is replaced with the menu/toolbar entity in the menu or toolbar set of the application gaining focus. If there is no menu/toolbar entity in the current menu or toolbar set with the same identifier, then the menu/toolbar entity from the menu bar or tool set of the application gaining focus is simply added to the current menu or toolbar set (i.e., the append 320 policy is applied). In any event, when the application loses focus, the menu/toolbar entity replaced will be reinstated. In accordance with this architecture, if a parent entity has a replace policy, there is no need to define policies for its child entities. For example, if the File menu of an application gaining focus has a Replace policy, then all of the menu items in the File menu of the current application will be replaced by the menu items in the File menu of the application gaining focus, regardless of any policies specified in the underlying menu items.

If the Append 320 policy is defined for a menu/toolbar entity, the menu/toolbar entity is added to the end of the menu bar or to the bottom of the tool set when the application gains focus. The appended menu or toolbar remains as long as the application stays in focus, and is de-applied once the application loses focus. In accordance with this architecture, if a parent entity has an append policy, there is no need to define policies for the child entities. For example, if the file menu of an application gaining focus has an append policy, then all of the menu items in the file menu gaining focus will be added to the file menu of the current application, regardless of any policies specified in the underlying menu items.

If the Persist 330 policy is defined for a menu/toolbar entity, the menu/toolbar entity is added to the end of the menu bar or to the bottom of the tool set as with the append 320 policy. However, the menu/toolbar entity remains in the menu or toolbar when the application loses focus, and is not removed until the application is destroyed. In all other respects, the Persist 330 policy is implemented in the same manner as the Append 320 policy.

None 340 policy is the default policy if no policy is defined. None 340 implements a replace 310 policy if possible. If the replace 310 policy can not be applied, e.g., there is no menu or toolbar with the same identifier in the menu bar or tool set, the append 320 policy is applied. Finally, if the Leave 350 policy is defined for and menu/toolbar entity, no attempt is made to reconfigure the menu bar or tool set.

FIG. 4 shows the policies that can be defined for items, e.g., menu items or buttons, whose parent is defined by the “Merge” 300 policy. These policies include the merge policy 300, the replace policy 310, the append policy 320, the leave policy 350, the override policy 420, the persist 330 policy, the place at policy 440, the place before policy 450, the place after policy 460, and the none policy 340.

Merge policy 300 can be designated in the case of a menu item which includes cascading menu sub-items. In such a case, if the menu item of an application gaining focus has a merge policy, and a menu item exists in the current application with the same identifier, the underlying sub-items of the menu item in the application gaining focus are merged together with the corresponding menu item of the current application in accordance with the policies defined in the sub-items.

If an item replace 310 is defined for an item in an application gaining focus, and an item with the same identifier exists in the current application's menu or the toolbar, the item currently in the current menu bar or toolbar is replaced with the item in the application gaining focus. If there is no item in the menu or tool bar with the same identifier, then the item append 320 policy is applied. When the application loses the focus, the prior item is reinstated.

If an item in an application gaining focus has an Override 420 policy, and an item with the same identifier exists in the menu or toolbar of the current application, the item currently in the menu or toolbar is replaced with the item having the override policy. However, unlike the replace 310 policy, the override 420 policy does not de-apply the policy when the application loses focus. Rather, the item remains until the application is destroyed. If there is no item in the menu or tool bar with the same identifier, then the item append 320 policy is applied. However, the item remains until the application is destroyed.

If an item in an application gaining focus has an Append 320 policy, the item is added at the end of the current menu or to the last button on the corresponding current toolbar. The item is retained as long as the application stays in focus, and is de-applied once the application loses focus.

If an item in an application gaining focus has a Persist 330 policy, the item is added as with the append 320 policy. However, the item remains when the application loses focus and is not removed until the application is destroyed.

An item Place At 440 policy in an item in an application gaining focus causes the item to be placed in the menu or toolbar at a designated position. An alphanumeric string may be used to indicate the position of the item and this string is associated to a same (or similar) string that may be attached to menu items in the current set of menu/toolbar entities. The item remains as long as the application stays in focus, and is de-applied once the application loses focus.

If an item in an application gaining focus has a Place Before 450 policy, that item is placed before a current item that is specified by its identifying name. For example, if the identifying name is “list” (e.g. Place Before List), the item will be placed before the current “list” item. If there is no item with the specified name, the system could, for example, apply the append policy as a default. The item remains as long as the application stays in focus, and is de-applied once the application loses focus.

Pursuant to an item Place After 460 policy, the item in an application gaining focus is placed after an item in the current application that is specified by an identifying name. For example, if the identifying name is “list” the item will be placed after the current “list” item. If there is no item with the specified name, the system could, for example, apply the append policy as a default. The item is retained as long as the application stays in focus, and is de-applied once the application loses focus.

If an item None 340 policy is selected, which is the default policy, the replace policy is applied, but if it is not possible to apply the replace policy, then the append policy is applied. For example, if there is no item with the same identifier in the current application, then the append policy is applied, since there are no items to replace.

Leave 350 policy, if designated, makes no changes to the menu bar or tool set, i.e., the leave policy 480 leaves the item off of the menu bar or tool set.

In accordance with other embodiments of the present invention, the persist policy can be used in conjunction with the other policies as a modifier. For example, as an alternative to specifying the override 420 policy the equivalent statement “replace+persist” in the properties file could apply the replace 310 policy and the persist 330 policy to the menu and toolbar. Thus, instead of de-applying the replace 310 policy when the application loses focus, the replace 310 policy would not be de-applied until the application is destroyed. Likewise, the persist policy 330 can, for example, be used as a modifier for the other policies such as append 320, merge 300 and others, by using the statements append+persist, merge+persist and the like. It should be noted that in the embodiment of FIG. 4, the persist 330 policy is equivalent to append+persist and the override 420 policy is equivalent to replace+persist.

In addition, although MDI applications do not generally change the menus on the menu bar or the order of the menus on the menu bar as the focus changes, the place at 440, place before 450, and place after 460 policies could be applied to the menu/toolbar entity, if desired.

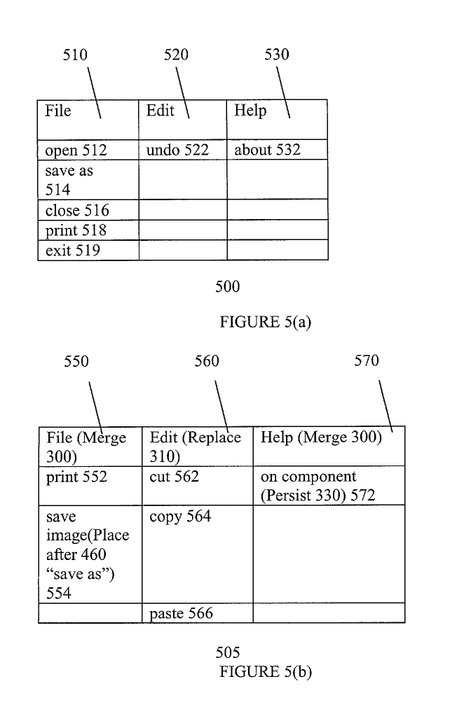

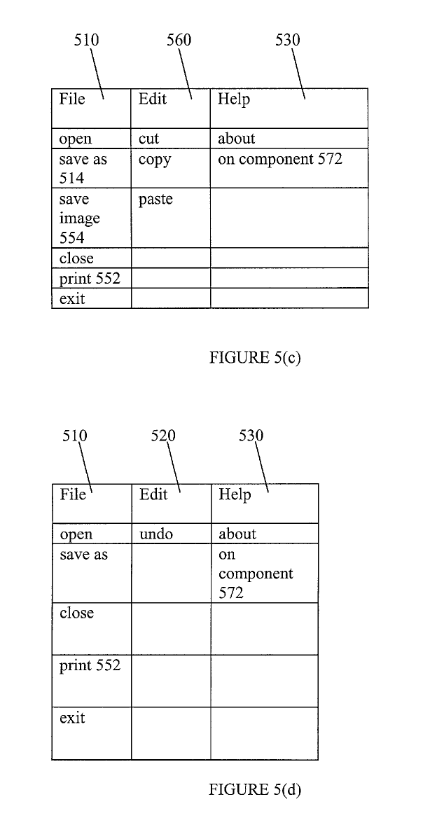

FIG. 5(a) is an illustrative representation of a current menu 500 configuration for a current MDI view (i.e., the menu currently displayed to a user.) The current menu 500 contains a file menu 510, an edit menu 520, and a help menu 530. The file menu 510 contains an open item 512, a save as 514 item, a close 516 item, a print 518 item and an exit 519 item. The edit 520 menu contains an undo 522 item, and the help menu 530 contains an about 532 item.

FIG. 5(b) is an illustrative representation of a menu configuration for a component 505. The menu configuration for the component 505 contains three component menus, a component file 550 menu, a component edit 560 menu, and a component help 570 menu. The component application's file menu 550 is set to the merge 300 policy and contains a component print 552 item and a component save image 554 item. The component save image 554 item is further defined by a place after 460 policy containing the alphanumeric string “save as.” A component edit 560 menu is defined by the replace 310 policy and contains a component cut 562 item, a component copy 564 item, and a component paste 566 item. The merge 300 policy is also defined for the component help 570 menu, and an on component 572 item contained in the component help 570 menu is further defined by the persist 330 policy.

FIG. 5(c) is an illustrative representation of the menu bar after the component gains focus. Since the component file 550 menu has a merge 300 policy, the polices for each item of the component file 550 menu are applied. Thus, component save image 554 is placed after the save as 514 menu item, and the component print 552 item replaces the print 518 item of the current menu 500. The component edit 560 menu has a replace policy, which causes the entire component edit 560 menu to replace the edit 520 menu and in so doing to hide the undo 522 item. The component help 570 menu has a merge 300 policy, so the policies for each item of the component help 570 menu are applied. Consequently, the on component 572 item is appended to the help menu 530.

FIG. 5(d) is an illustrative representation of the menu bar after the component 505 loses focus. When the component 505 loses focus, the policies for the component 505, except for the persist 330 policy, are de-applied. Thus, the menus 510, 520, 530 revert back to their prior state except for the help menu 530, where the on component 572 remains, since the persist 330 policy is defined by the on component 572.

The policies underlying the tool bar and menu bar elements are contained in a properties file, and are read by the system as data (step 130 of FIG. 2) when a container is created for an application or view. A key property menubar can be used to introduce the individual menu items in the menu bar (e.g. menubar=file edit help). The key property toolbars can be used to introduce a set of toolbars (e.g., toolbars=standard), and then the name defined can be used to further define the toolbar items (e.g. standard=cut edit paste). Table 1 shows a portion of an exemplary properties file which implements the menu elements of FIG. 5(b) as well as some toolbar elements:

TABLE 1

menubar = file edit help
file = print saveimage
edit = cut copy paste
help = oncomponent
fileLabel = File
editLabel = Edit
helpLabel = Help
printLabel = print
printImage = print.gif
saveimageLabel = Save image
cutLabel = cut
cutImage = cut.gif
copyLabel = copy
copyImage = copy.gif
pasteLabel = paste
pasteImage = paste.gif
oncomponentLabel = on component
toolbars = standard
standard = cut copy paste print
standardMDIName = Standard
fileMDIPolicy = Merge
editMDIPolicy = Replace
helpMDIPolicy = Merge
saveimageMDIPolicy = PlaceAfter-save as
oncomponentMDIPolicy = Persist
standardMDIPolicy = Merge

The component application's file menu 550 is set to the merge 300 policy by the statement “fileMDIPolicy=Merge”and the statement “saveimageMDIPolicy=PlaceAfter-save as” further defines the component save image 554 item. An “editMDIPolicy=Replace” statement defines the component edit 560 menu. The declaration “helpMDIPolicy=Merge” defines the component help 570 menu, and an “oncomponentMDIPolicy=Persist” further defines the oncomponent 572 item contained in the component help 570 menu. When a view corresponding to the application having this properties file (hereinafter “AA”) gains focus, the print item on the menu will be replaced by AA's print item. Similarly the cut, copy, paste and print buttons on the current standard toolbar will be replaced by AA's buttons, or AA's buttons will be appended if such items do not exist on the current standard toolbar. The file menu will also receive a new menu item for saving an image and this will appear after the save as menu item. The edit menu on the current menu bar will be completely replaced by AA's edit menu. The help menu will have an on component item appended. When the component loses the focus all items will revert back to the way they were before the component gained the focus except for the on component entity on the help menu which will remain.

The menu and toolbar policies described above are used to control the appearance of menu/toolbar entities as applications are created, destroyed, and brought into and out of focus. However, it may also be desirable to change the appearance of menu/toolbar entities based upon the “state” of the application. For example, it may be desirable for an application to have different menu/toolbar entities in a system mode than in a normal mode. Similarly, after a user has selected an item in an application window, it may be desirable to make that item unavailable or disabled (e.g. greyed out). In accordance with a preferred embodiment of the present invention, the characteristics of the menu and tool bars as the application changes states is controlled via a data file. Preferably, the data file is the same data file used for the menu and tool bar policies.

In accordance with this embodiment of the present invention, an application can have a plurality of states, and each state, in turn, can have state-parts and sub-states. A sub-state is a further definition of the state which is exclusive (e.g., an application can only be in one sub-state of a state at any given time). However, a sub-state can, itself, have a further sub-state. A state part is a further definition of the state which is non-exclusive (e.g., the application can be in multiple state parts of a state at any given time). The current state, sub-state, and/or state-part of an application is defined by the underlying source code of the application in a conventional manner. For example, the code “Static final String OnceSelectedState=“OneSelected”; statesD.setState(OneSelectedState)” or the like could be used to set the state of an application to a OneSelected state.

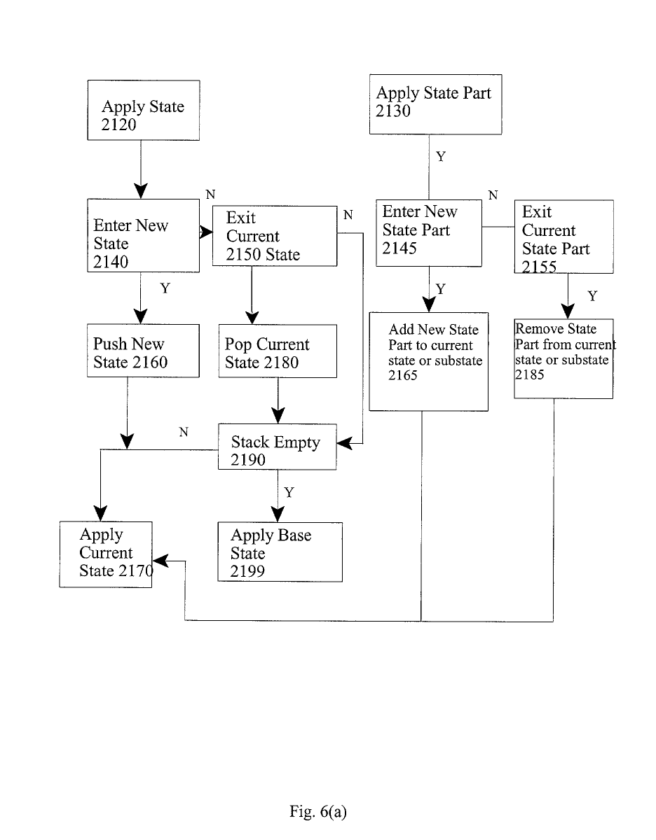

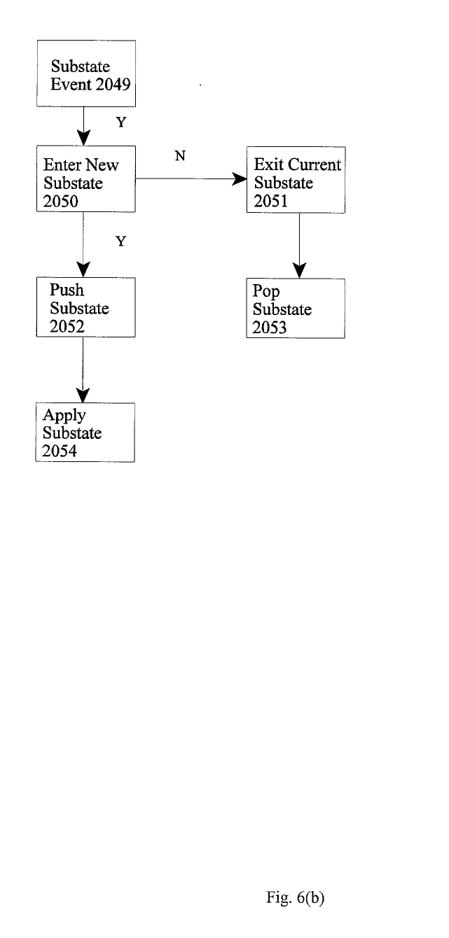

FIG. 6 shows a flow chart of an exemplary method by which the state/data driven approach to configuring menus and toolbars can be implemented. When an application has been created (or opened) in a view, the information in the applications's properties file (including the policy information and the state information) is incorporated into the container for the application in the manner described above with regard to FIG. 2. At this time, it is initialized with a base state in accordance with the information derived from the properties file. In this regard, the base state of an application is defined by the menu and tool bar definitions in the properties file (See, e.g., Table 1) which are not associated with specific states. Preferably, each open application has associated therewith a respective stack for maintaining its current state, sub-state, and/or state parts.

State changes are caused by a corresponding call function in the code of the application. State changes could relate to states (step 2120), e.g., changing the current state of the application, state parts (step 2130), e.g., changing the current state part of the application, or sub-states (step 2049 ), e..g, changing the current sub-state of the application.

If the application is entering a new state (step 2140), a new state is pushed onto the top of a stack for the view (step 2160), and the menu/toolbar entities of the currently focused application are modified to conform to the new state (step 2170), i.e., the state on the top of the stack. If the application exits the current state (step 2150), a state on the top of the stack is popped off the stack (step 2180), and if a stack is not empty (step 2190), the menu/toolbar entities of the currently focused application are modified to conform to the state now currently on the top of the stack (step 2170), i.e., the prior state. However, if the stack is empty, the system applies a base state as defined for the application (step 2199). As an alternative to checking for an empty stack, the system could simply initialize the stack with the base state for the view when the application is created.

If the application is entering a new state part (step 2145 ), a new state part is added to the current state or sub-state on the top of the stack for the current application (step 2165 ), and the menu/toolbar entities of the currently focused application are modified to conform to the current state-part (step 2175). It should be noted that the system need only implement the menu/toolbar characteristics defined by the state-part because the menu/tool bar characteristics dictated by the underlying state would have already been implemented. If the application is exiting a current state part (step 2155), the state part is removed from the state or sub-state on the top of the stack, and the menu/toolbar characteristics of the current state (or sub-state) on the stack are applied (including any remaining state parts on the current state (or sub-state).

As mentioned above, each state can also have one or more sub-states. When an application is in a sub-state, the characteristics of the underlying state, as well as the additional characteristics of the sub-state, are applied. Referring to FIG. 6, if an application enters a new sub-state (step 2050), then the new sub-state is pushed onto the stack (step 2052), and the menu/toolbar characteristics for the sub-state are applied to the application. In this regard, since the characteristics of the underlying state have previously been applied, only the changed characteristics dictated by the sub-state need to be applied in step 2054. If the application exits the current sub-state, then the current sub-state is popped off of the stack, and the characteristics of the underlying state are applied to the application (step 2170).

When a state is pushed to the stack (step 2160), the menu/toolbar characteristics are applied for that state (step 2170), and characteristics associated with any prior states are disregarded. In other words, states are mutually exclusive. Sub-states are similarly mutually exclusive. In contrast, when a state part is pushed to the stack (step 2165), the characteristics for the current state part, the current state (or if the stack is empty, the base state) are applied. In other words, state parts are not mutually exclusive.

As an illustration, consider a stack of substates—state1.state12.state123. State12 and state123 are sub-states (modifiers) of state1 and state1.state12 respectively. States are exclusive in that the full state definition is state1 .state12. state123 and these would be replaced if the state was set to state2. Each sub-state could have a set of state parts, e.g., state1.state12+statepart12P1. If state definitions conflict then the ones higher up on the stack take precedence.

The following is an exemplary manner in which that state driven architecture described above can be implemented. Each item which can exist in multiple states (each toolbar, button, menu etc) can be represented by a StateItem object which is created when the item is created. A state item object can have listener objects associated with it and a listener is attached which can make the necessary changes for the type of object concerned (there is one class of listener for menu items, one for buttons etc.) and each listener is a separate object which is an instance of one of these classes. The states object (which maintains the state stack) keeps a hashtable of the state items, indexed by the name of the obect. A second index is maintained which records the names of the stated items against their possible states in the system (as recorded in the specification file) When a state change occurs the second index is scanned to determine the items which may have new settings for the new state and then the names derived from this used to access all the StateItem objects. The listeners on these are then fired, passing in the new state. The listener then accesses the specification (data file) which defines the input items and their states to accesses the full details of its new format and then makes the required adjustments.

FIG. 7 is an exemplary representation of portion of a properties file 2299 for an application in accordance with the second or third embodiments of the present invention. As explained above, the properties file is a data file, and in order to alter the functionality of the menus or toolbars for a particular application, a user or developer simply edits the contents of the properties file for the application. In this manner, different menu configurations for different states and state parts can be implemented without having to modify source code. In accordance with the preferred embodiment of FIG. 7, the syntax for defining states, state parts, and sub-states in a properties file is:

States=state.substate.substate . . . [state-part, state-part, . . .].

Therefore, the property file of FIG. 7 defines a SystemMode 2200 state, a NormalMode 2210 state, a OneSelected 2202 state, a ManySelected 2204 state, and an Active 2230 state. Moreover, the SystemMode 2200 state has a SysModeOnly 2240 state part, and the NormalMode 2210 state has a SysModeNotAllowed 2250 state part.

State parts of the base state can be designated with the syntax:

states=[state-part, state-part].

Referring to FIG. 7, the base state (which as described above, is defined by the menu and toolbar definitions in the properties file which are not associated with any state) has state parts Nopdselected 2260, Notaskselected 2270, and Canmsgstep 2280.

Sub-states, in turn, can be defined with the syntax “State.substate.substate”. For example, if we were to add a sub-state “Beta” to the Active state of FIG. 7, the State declaration would be modified to read:

Sates=Active.Beta SystemMode[SysModeOnly] NormalMode[SysModeNotAllowed]

OneSelected ManySelected \

[Nopdselected,Notaskselected,Canmsgstep, \]

After the desired states, sub-states, and state parts, the following syntax can be used to enable or disable (e.g. grey out) a menu or toolbar item:

<state specification><property>=<item,item,item . . . >

The <state specification> field is used to specify in which state, state part, or sub-state the disabling or enabling occurs. Preferably, the <state specification> follows a <state.substate+statepart> format. If the statement only contains a <+statepart>, the state part applies to the state currently on top of the state stack. The <property> field can contain an “Off” 2212 declaration, which disables the item, or an “on” 2294 declaration, which enables the item, and the <item> field defines the menu item to which the <property> is applied.

For example, in FIG. 7, a download 2205 and a redownload 2215 menu/toolbar entities are disabled in the active 2230 state, since the “Off” 2212 declaration is in the <property> field of the statement and the <state specification> field references the active 2230 state. A systemtask 2225 is disabled when the system is in the NormalMode 2210 state and the SysModeNotAllowed 2250 state part, because the “off” 2212 declaration is in the <property> field and the <state specification> field references both the NormalMode 2210 state and the SysModeNotAllowed 2250 sub-state separated by a “+”. The systemtask 2225 is also disabled when the system is in the SystemMode 2200 state and the SysModeOnly 2240 state part, because the “off” 2212 declaration is in the <property> field and the <state specification> field references both the SystemMode 2200 state and the SysModeOnly 2240 state part separated by a “+”. A taskmenu 2298, a systemtask 2225, and a taskfunction 2296 are enabled when the NoTaskSelected 2270 state part is active, regardless of the current state, since only the NoTaskSelected 2270 state part is specified in the <state specification>, with a preceding “+”, and the “on” 294 declaration is in the <property> field. To disable the taskmenu 2298 in the sub-state example set forth above, the statement Active.Betaoff=taskmenu could be used.

To allow the dynamic modification of all items defined in the properties file, the property file includes a context-addressing syntax that specifies different user interface states. Each item has the general format:

<item><state specification><property>=<definition>.

The <item> parameter specifies the item that receives the action. The <state specification> specifies in which state the system applies the dynamic modification, and the <property> defines what part of the item is changed, e.g., the menu label or the toolbar button. The <definition> parameter provides the value applied by the statement.

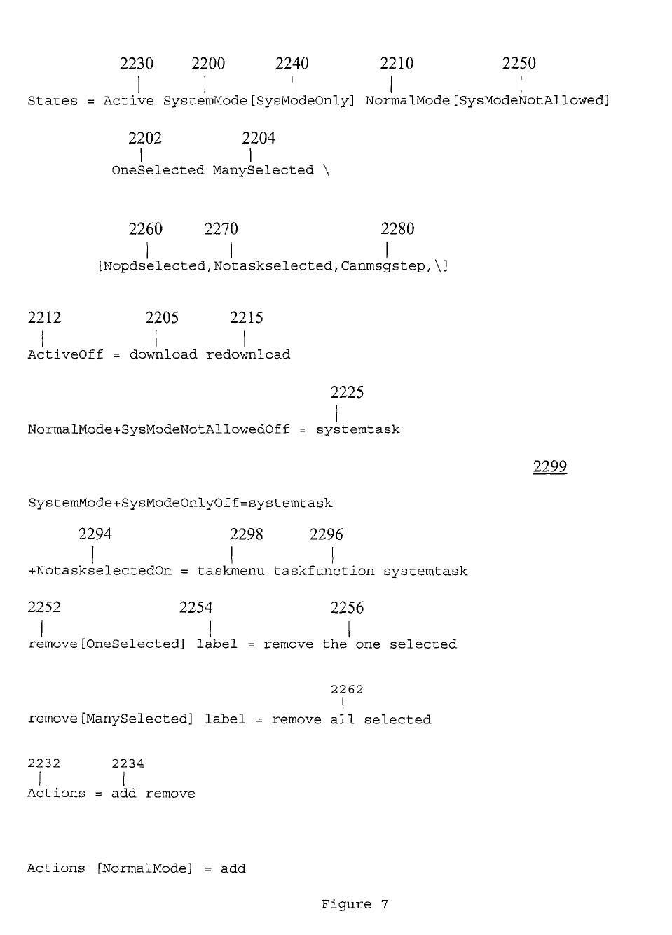

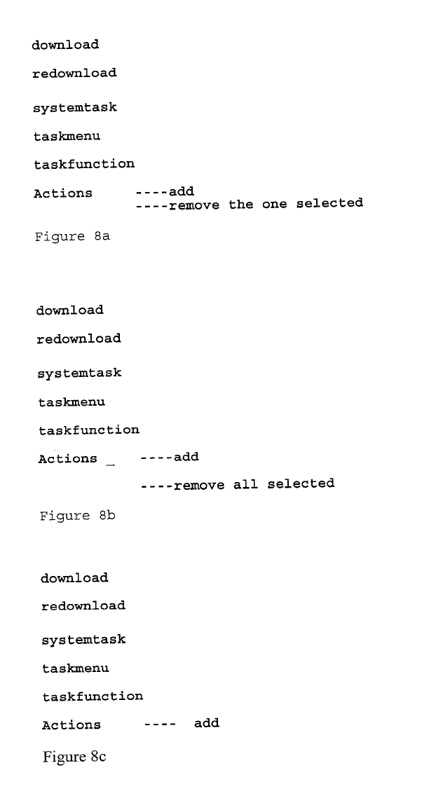

For example, turning to FIGS. 8(a) and 7, a remove menu item is renamed “”remove the one selected” when the system enters the oneselected 2202 state, because the <item> field contains a remove 2252, the <state specification> field is the OneSelected 2202 state, the <property> field is a label 2254, and the definition contains the string “remove the one selected”. The label 2254 in the <property> field identifies the remove 2252 as a label in a menu. Turning to FIGS. 8(b) and 7, the remove 2252 is renamed “remove all selected” when the system enters the ManySelected 2204 state, since the <item> field contains the remove 2252 item, the <state specification> field has the ManySelected 2204 state, the <property> field is defined as the label 2254, and the definition field contains “remove all selected”.

A similar syntax could also be used to remove (as opposed to greying out) a menu or tool bar item. Referring to FIGS. 6 and 8c, an Actions menu items includes a cascading add menu item and remove menu item. Continuing to the next line, Actions 2232 is used as the <item>, NormalMode 2200 is used as the <state specification>, and only add 2234 is listed in the <definition>, so that when the system is in the NormalMode 2200, only the add menu item is displayed.

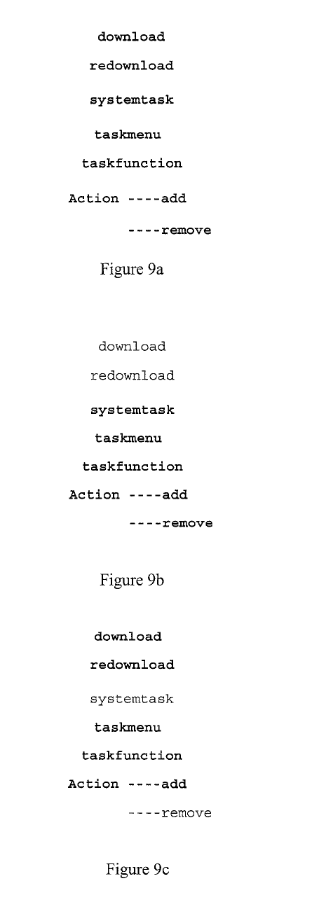

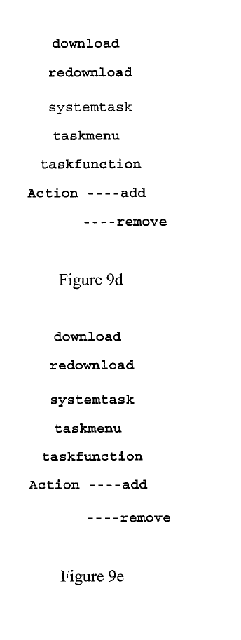

FIG. 9(a) is an illustrative representation of a pull down menu in the MDI environment in a base state. When the view is opened, the stack initializes with the base state along with any current states, state parts, or sub-states. A download menu item, a redownload menu item, a systemtask menu item, a taskmenu menu item, a taskfunction menu item, and an Action menu item with cascading add menu item and remove menu item are present.

FIG. 9(b) is an illustrative representation of the menu after the active 2230 state is pushed to the stack. All of the menu items are still present, however, the download menu item and redownload menu item are disabled because of the “off” 2212 declaration in the properties file 2299 of FIG. 7.

FIG. 9(c) is an illustrative representation of the menu after the active 2230 state has been popped from the stack, and the NormalMode 2210 state and the SysModeNotAllowed 2250 state part are pushed to the stack. The download and redownload 320 menu items return to the enabled state because the state that triggered the “off” 2212 declaration for the download menu item and redownload menu item has been popped from the stack, and the “off” 2212 declaration for the current state and state part disables the systemtask menu item. The remove menu item is not displayed because the Actions 2232 declaration does not allow the remove menu item in the NormalMode 2210 state.

FIG. 9(d) is an illustrative representation of the menu after the NormalMode 2210 state and the SysModeNotAllowed 2250 state part have been popped from the stack, and the SystemMode 2200 state and the SysModeOnly 2240 state part are pushed to the stack. The “off” 2212 declaration for the systemtask 2225 disables the systemtask menu item. However, after the NormalMode 2210 state and the SysModeNotAllowed 2250 state part had been popped from the stack, but before the SystemMode 2200 state and the SysModeOnly 2240 state part were pushed to the stack, the systemtask menu item was enabled, since the system reverted to the base state after the SysModeNotAllowed 250 state had been popped from the stack.

FIG. 9(e) is an illustrative representation of the menu bar after the Notaskselected 2260 state part is applied. The “on” 2212 declaration enables the systemtask menu item, the taskmenu menu item, and the taskfunction menu item. However, since the taskmenu menu item and taskfunction menu item are already enabled, the change in the systemtask menu item is the only visible change in FIG. 9e.

The present invention is also directed to any computer readable media having stored thereon the computer executable processes described above, including, without limitation, floppy disks, CD ROMs, tapes, hard disks, and the like.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for generating menu/toolbar entities on a graphical user interface, comprising the steps of:
providing an application which can be displayed in a frame of a graphical user interface, the application having a corresponding set of menu/toolbar entities, the application being in one of a respective plurality of application states at any given time, information indicative of an application state characteristic for each application state of the application being contained in a data file, each application state characteristic defining a display characteristic of at least one of the set of menu/toolbar entities; and
generating a displayed set of menu/toolbar entities on the graphical user interface based upon the application state characteristic of a current one of the application states of the application.

2. A method for generating menu/toolbar entities on a graphical user interface having a parent frame for displaying menu/toolbar items and a plurality of child frames, comprising the steps of:
providing a set of applications which can be displayed in the plurality of child frames, each application having a corresponding set of menu/toolbar entities, each application being in one of a respective plurality of application states at any given time, information indicative of an application state characteristic for each application state of each application being contained in a data file, each application state characteristic defining a display characteristic of at least one of the set of menu/toolbar entities, and
generating a displayed set of menu/toolbar entities on the graphical user interface based upon the application state characteristic of a current one of the application states of a currently focused one of the applications.

3. The method of claim 2, wherein each application has a corresponding data file.

4. The method of claim 1, wherein the display characteristic is one of an enabled menu/toolbar entity and a disabled menu/toolbar entity.

5. The method of claim 4, wherein the data file includes text in a format of
<state specification><property>=<item,item,item . . . >, wherein a state specification field identifies the application state, the item field identifies the menu/toolbar entities which are modified, and the property field indicates whether the application state enables or disables the menu/toolbar entities.

6. The method of claim 5, wherein the menu/toolbar entities include menu items and toolbar items.

7. The method of claim 1, wherein the application states include a plurality of states and a plurality of state parts, and wherein the application can, at any given time, be in one of the plurality of states and in zero or more of the plurality of state parts.

8. A method of configuring a plurality of menu/toolbar entities for an application comprising the steps of:
selecting a plurality of states for an application, the application having associated therewith a plurality of menu/toolbar entities for displaying on a graphical user interface;
selecting a state characteristic for each state, the state characteristic defining characteristics of a plurality of menu/toolbar entities of the application based on the state, information defining the state characteristics being stored in a data file;
entering the application into a current one of the plurality of states; and
applying the state characteristic of the current state of the application to the plurality of menu/toolbar entities displayed on a graphical user interface, based upon the information in the data file.

9. A method of configuring a plurality of menu/toolbar entities for an application comprising the steps of:
selecting a first plurality of states for an application, the application having associated therewith a plurality of menu/toolbar entities for displaying on a graphical user interface;
selecting a second plurality of state parts, each state part being associated with one or more of the plurality of states.
selecting a state characteristic for each state and each state part, the state characteristic defining characteristics of a plurality of menu/toolbar entities of the application based on the state, information defining the state characteristics being stored in a data file;
entering the application into a current one of the plurality of states;
applying the state characteristic of the current state of the application to the plurality of menu/toolbar entities displayed on a graphical user interface, based upon the information in the data file;
entering the application into a current one of the plurality of state parts for the current state;
applying the state characteristic of the current state part to the plurality of menu/toolbar entities displayed on a graphical user interface, based upon the information in the data file.

10. The method as recited in claim 8 wherein the state further comprises a sub-state.

11. The method as recited in claim 8 wherein the state farther comprises a state part.

12. The method as recited in claim 8 wherein the state is a base state.

13. The method as recited in claim 9 wherein the state is a base state.

14. The method as recited in claim 8 wherein the step of entering further comprises pushing the state on a stack.

15. The method as recited in claim 10 wherein the step of entering further comprises pushing the sub-state on a stack.

16. The method as recited in claim 11 wherein the step of entering further comprises adding the state part to a current state on a stack.

17. The method of claim 9, further comprising entering a new current one of the plurality of states;
deapplying the state characteristics of the current state and current state part; and
applying the state characteristic of the new current state of the application to the plurality of menu/toolbar entities displayed on the graphical user interface, based upon the information in the data file.

18. The method of claim 17, wherein the step of deapplying further comprises popping the current state and current state part from a stack, and wherein the step of applying further comprises pushing the new current state on the stack.

19. A method for generating menu/toolbar entities on a graphical user interface having a parent frame for displaying menu/toolbar items and a plurality of child frames, comprising the steps of:
providing a set of applications which can be displayed in the plurality of child frames, each application having a corresponding set of menu/toolbar entities, information indicative of a policy for each menu/toolbar entity of each application being contained in a data file, each application being in one of a respective plurality of application states at any given time, information indicative of an application state characteristic for each application state of each application being contained in the data file, each application state characteristic defining a display characteristic of at least one of the set of menu/toolbar entities; and
generating a displayed set of menu/toolbar entities on the graphical user interface based upon the policies of the menu/toolbar entities for a currently focused one of the applications and upon the application state characteristic of a current one of the application states of the currently focused application.

20. The method of claim 19, wherein each application has a corresponding data file.

21. The method of claim 19, wherein the providing step further includes selecting the policy for each menu/tool bar entity from a set of policies and placing information indicative of the policy into the data file, the set of policies including a replace policy and an append policy, each menu/toolbar entity having an identifier, and wherein the generating step includes, for each menu/toolbar entity in an application gaining focus, comparing the identifier of the menu/toolbar entity to the identifier of each menu/toolbar entity in a current set of menu/toolbar entities, and, upon finding a match:
replacing the matched menu/toolbar entity of the current set of menu/toolbar entities with the matched menu/toolbar entity of the application gaining focus in the displayed set of menu/toolbar entities when the policy of the matched menu/toolbar entity of the application gaining focus is the replace policy;
adding the matched menu/toolbar entity of the application gaining focus to the displayed set of menu/toolbar entities when the policy of the matched menu/toolbar entity of the application gaining focus is the append policy.

22. The method of claim 19, wherein the set of menu/toolbar entities includes a toolbar having a set of toolbar items, and a menu bar having a set of menus, each menu having a corresponding set of menu items, and wherein the menu bar, the toolbar, each menu, each menu item, and each toolbar item each have a respective policy.

23. The method of claim 21, wherein the providing step further includes
selecting the respective policy for each menu from a set of policies and placing information indicative of the policy into the data file, the set of policies including a merge policy, a replace policy and an append policy, each menu having an identifier, and wherein
the generating step includes, for each menu in an application gaining focus, comparing the identifier of the menu bar to the identifier of each menu in a current set of menu/toolbar entities, and, upon finding a match:
replacing the matched menu of the current set of menu/toolbar entities with the matched menu of the application gaining focus in the displayed set of menu/toolbar entities when the policy of the matched menu of the application gaining focus is the replace policy;
adding the matched menu of the application gaining focus to the displayed set of menu/toolbar entities when the policy of the matched menu of the application gaining focus is the append policy; and
generating the displayed set of menu/toolbar entities on the graphical user interface based upon the policies of the menu items of the matched menu of the application gaining focus, when the policy of the matched menu of the application gaining focus is the merge policy.

24. The method of claim 22, wherein the providing step further includes
selecting the respective policy for each tool bar from a set of policies and placing information indicative of the policy into the data file, the set of policies including a merge policy, a replace policy and an append policy, each tool bar having an identifier, and wherein
the generating step includes, for each tool bar in an application gaining focus, comparing the identifier of the menu bar to the identifier of each tool bar in a current set of menu/toolbar entities, and, upon finding a match:
replacing the matched tool bar of the current set of menu/toolbar entities with the matched tool bar of the application gaining focus in the displayed set of menu/toolbar entities when the policy of the matched tool bar of the application gaining focus is the replace policy;
adding the matched tool bar of the application gaining focus to the displayed set of menu/toolbar entities when the policy of the matched tool bar of the application gaining focus is the append policy; and
generating the displayed set of menu/toolbar entities on the graphical user interface based upon the policies of the tool bar items of the matched tool bar of the application gaining focus, when the policy of the matched tool bar of the application gaining focus is the merge policy.

25. The method of claim 23, further comprising the steps of, when the matched
menu bar has the merge policy:
selecting the respective policy for each menu item from a set of policies and placing information indicative of the policy into the data file, the set of policies including a replace policy and an append policy, each menu item having an identifier, and wherein
the generating step includes, for each menu item in an application gaining focus, comparing the identifier of the menu item to the identifier of each menu bar in a current set of menu/toolbar entities, and, upon finding a match:
replacing the matched menu item of the current set of menu/toolbar entities with the matched menu item of the application gaining focus in the displayed set of menu/toolbar entities when the policy of the matched menu item of the application gaining focus is the replace policy;
adding the matched menu item of the application gaining focus to the displayed set of menu/toolbar entities when the policy of the matched menu item of the application gaining focus is the append policy.

26. The method of claim 25, further comprising the steps of, when the matched tool
bar has the merge policy:
selecting the respective policy for each tool bar item from a set of policies and placing information indicative of the policy into the data file, the set of policies including a replace policy and an append policy, each tool bar item having an identifier, and wherein
the generating step includes, for each tool bar item in an application gaining focus, comparing the identifier of the tool bar item to the identifier of each tool bar item in a current set of menu/toolbar entities, and, upon finding a match:
replacing the matched tool bar item of the current set of menu/toolbar entities with the matched tool bar item of the application gaining focus in the displayed set of menu/toolbar entities when the policy of the matched tool bar item of the application gaining focus is the replace policy;
adding the matched tool bar item of the application gaining focus to the displayed set of menu/toolbar entities when the policy of the matched tool bar item of the application gaining focus is the append policy.

27. The method of claim 19, wherein the generating step includes the steps of:
monitoring an event queue for one of a create event, a destroy event, and a focus event;
upon detecting a create event, creating a JAVA container corresponding to an application which caused the create event using the information indicative of the policies of the application from the data file corresponding to the application;
upon detecting a gain focus event, applying the policies of an application gaining focus based upon information contained in the JAVA container for the application gaining focus;
upon detecting a lose focus event, deapplying the policies of an application losing focus based upon information contained in the JAVA container for the application losing focus; and
upon detecting a destroy event, destroying the JAVA containing corresponding to an application which caused the destroy event.

28. The method of claim 22, wherein the providing step further includes
selecting the respective policy for each menu bar from a set of policies and placing information indicative of the policy into the data file, the set of policies including a merge policy, a replace policy and an append policy, each menu bar having an identifier, and wherein
the generating step includes, for each menu bar in an application gaining focus, comparing the identifier of the menu bar to the identifier of each menu in a current set of menu/toolbar entities, and, upon finding a match:
replacing the matched menu bar of the current set of menu/toolbar entities with the matched menu bar of the application gaining focus in the displayed set of menu/toolbar entities when the policy of the matched menu bar of the application gaining focus is the replace policy;
adding the matched menu bar of the application gaining focus to the displayed set of menu/toolbar entities when the policy of the matched menu bar of the application gaining focus is the append policy; and
generating the displayed set of menu/toolbar entities on the graphical user interface based upon the policies of the menus of the matched menu bar of the application gaining focus, when the policy of the matched menu bar of the application gaining focus is the merge policy.

29. The method of claim 19, wherein the display characteristic is one of an enabled menu/toolbar entity and a disabled menu/toolbar entity.

30. The method of claim 29, wherein the data file includes text in a format of
<state specification><property>=<item,item,item . . . >, wherein a state specification field identifies the application state, the item field identifies the menu/toolbar entities which are modified, and the property field indicates whether the application state enables or disables the menu/toolbar entities.

31. The method of claim 30, wherein the menu/toolbar entities include menu items and toolbar items.

32. The method of claim 19, wherein the application states include a plurality of states and a plurality of state parts, and wherein each application can, at any given time, be in one of the plurality of states and in zero or more of the plurality of state parts.

33. The method of claim 2, wherein the display characteristic is one of an enabled menu/toolbar entity and a disabled menu/toolbar entity.

34. The method of claim 33, wherein the data file includes text in a format of
<state specification><property>=<item,item,item . . . >, wherein a state specification field identifies the application state, the item field identifies the menu/toolbar entities which are modified, and the property field indicates whether the application state enables or disables the menu/toolbar entities.

35. The method of claim 34, wherein the menu/toolbar entities include menu items and toolbar items.

36. The method of claim 2, wherein the application states include a plurality of states and a plurality of state parts, and wherein the application can, at any given time, be in one of the plurality of states and in zero or more of the plurality of state parts.

37. A computer-readable medium, having stored thereon, computer executable process steps operative to control a computer to generate menu/toolbar entities on a graphical user interface having a parent frame for displaying menu/toolbar items and a plurality of child frames, the steps comprising:
providing a set of applications which can be displayed in the plurality of child frames, each application having a corresponding set of menu/toolbar entities, information indicative of a policy for each menu/toolbar entity of each application being contained in a data file, each application being in one of a respective plurality of application states at any given time, information indicative of an application state characteristic for each application state of each application being contained in the data file, each application state characteristic defining a display characteristic of at least one of the set of menu/toolbar entities; and
generating a displayed set of menu/toolbar entities on the graphical user interface based upon the policies of the menu/toolbar entities for a currently focused one of the applications and upon the application state characteristic of a current one of the application states of the currently focused application.

38. The computer readable medium of claim 37, wherein each application has a corresponding data file.

39. The computer readable medium of claim 37, wherein the providing step further includes selecting the policy for each menu/tool bar entity from a set of policies and placing information indicative of the policy into the data file, the set of policies including a replace policy and an append policy, each menu/toolbar entity having an identifier, and wherein
the generating step includes, for each menu/toolbar entity in an application gaining focus, comparing the identifier of the menu/toolbar entity to the identifier of each menu/toolbar entity in a current set of menu/toolbar entities, and, upon finding a match:
replacing the matched menu/toolbar entity of the current set of menu/toolbar entities with the matched menu/toolbar entity of the application gaining focus in the displayed set of menu/toolbar entities when the policy of the matched menu/toolbar entity of the application gaining focus is the replace policy;
adding the matched menu/toolbar entity of the application gaining focus to the displayed set of menu/toolbar entities when the policy of the matched menu/toolbar entity of the application gaining focus is the append policy.

40. The computer readable medium of claim 37, wherein the set of menu/toolbar entities includes a toolbar having a set of toolbar items, and a menu bar having a set of menus, each menu having a corresponding set of menu items, and wherein the menu bar, the toolbar, each menu, each menu item, and each toolbar item each have a respective policy.

41. The computer readable medium of claim 40, wherein the providing step further includes
selecting the respective policy for each menu from a set of policies and placing information indicative of the policy into the data file, the set of policies including a merge policy, a replace policy and an append policy, each menu having an identifier, and wherein
the generating step includes, for each menu in an application gaining focus, comparing the identifier of the menu bar to the identifier of each menu in a current set of menu/toolbar entities, and, upon finding a match:
replacing the matched menu of the current set of menu/toolbar entities with the matched menu of the application gaining focus in the displayed set of menu/toolbar entities when the policy of the matched menu of the application gaining focus is the replace policy;
adding the matched menu of the application gaining focus to the displayed set of menu/toolbar entities when the policy of the matched menu of the application gaining focus is the append policy; and
generating the displayed set of menu/toolbar entities on the graphical user interface based upon the policies of the menu items of the matched menu of the application gaining focus, when the policy of the matched menu of the application gaining focus is the merge policy.

42. The computer readable medium of claim 41, wherein the providing step further includes
selecting the respective policy for each tool bar from a set of policies and placing information indicative of the policy into the data file, the set of policies including a merge policy, a replace policy and an append policy, each tool bar having an identifier, and wherein
the generating step includes, for each tool bar in an application gaining focus, comparing the identifier of the menu bar to the identifier of each tool bar in a current set of menu/toolbar entities, and, upon finding a match:
replacing the matched tool bar of the current set of menu/toolbar entities with the matched tool bar of the application gaining focus in the displayed set of menu/toolbar entities when the policy of the matched tool bar of the application gaining focus is the replace policy;
adding the matched tool bar of the application gaining focus to the displayed set of menu/toolbar entities when the policy of the matched tool bar of the application gaining focus is the append policy; and
generating the displayed set of menu/toolbar entities on the graphical user interface based upon the policies of the tool bar items of the matched tool bar of the application gaining focus, when the policy of the matched tool bar of the application gaining focus is the merge policy.

43. The computer readable medium of claim 42, further comprising the steps of,
when the matched menu bar has the merge policy:
selecting the respective policy for each menu item from a set of policies and placing information indicative of the policy into the data file, the set of policies including a replace policy and an append policy, each menu item having an identifier, and wherein
the generating step includes, for each menu item in an application gaining focus, comparing the identifier of the menu item to the identifier of each menu bar in a current set of menu/toolbar entities, and, upon finding a match:
replacing the matched menu item of the current set of menu/toolbar entities with the matched menu item of the application gaining focus in the displayed set of menu/toolbar entities when the policy of the matched menu item of the application gaining focus is the replace policy;
adding the matched menu item of the application gaining focus to the displayed set of menu/toolbar entities when the policy of the matched menu item of the application gaining focus is the append policy.

44. The computer readable medium of claim 43, further comprising the steps of,
when the matched tool bar has the merge policy:
selecting the respective policy for each tool bar item from a set of policies and placing information indicative of the policy into the data file, the set of policies including a replace policy and an append policy, each tool bar item having an identifier, and wherein
the generating step includes, for each tool bar item in an application gaining focus, comparing the identifier of the tool bar item to the identifier of each tool bar item in a current set of menu/toolbar entities, and, upon finding a match:
replacing the matched tool bar item of the current set of menu/toolbar entities with the matched tool bar item of the application gaining focus in the displayed set of menu/toolbar entities when the policy of the matched tool bar item of the application gaining focus is the replace policy;
adding the matched tool bar item of the application gaining focus to the displayed set of menu/toolbar entities when the policy of the matched tool bar item of the application gaining focus is the append policy.

45. The computer readable medium of claim 37, wherein the generating step includes the steps of:
monitoring an event queue for one of a create event, a destroy event, and a focus event;
upon detecting a create event, creating a JAVA container corresponding to an application which caused the create event using the information indicative of the policies of the application from the data file corresponding to the application;
upon detecting a gain focus event, applying the policies of an application gaining focus based upon information contained in the JAVA container for the application gaining focus;
upon detecting a lose focus event, deapplying the policies of an application losing focus based upon information contained in the JAVA container for the application losing focus; and
upon detecting a destroy event, destroying the JAVA containing corresponding to an application which caused the destroy event.

46. The computer readable medium of claim 40, wherein the providing step further includes
selecting the respective policy for each menu bar from a set of policies and placing information indicative of the policy into the data file, the set of policies including a merge policy, a replace policy and an append policy, each menu bar having an identifier, and wherein
the generating step includes, for each menu bar in an application gaining focus, comparing the identifier of the menu bar to the identifier of each menu in a current set of menu/toolbar entities, and, upon finding a match:
replacing the matched menu bar of the current set of menu/toolbar entities with the matched menu bar of the application gaining focus in the displayed set of menu/toolbar entities when the policy of the matched menu bar of the application gaining focus is the replace policy;
adding the matched menu bar of the application gaining focus to the displayed set of menu/toolbar entities when the policy of the matched menu bar of the application gaining focus is the append policy; and
generating the displayed set of menu/toolbar entities on the graphical user interface based upon the policies of the menus of the matched menu bar of the application gaining focus, when the policy of the matched menu bar of the application gaining focus is the merge policy.

47. The computer readable medium of claim 37, wherein the display characteristic is one of an enabled menu/toolbar entity and a disabled menu/toolbar entity.

48. The computer readable medium of claim 47, wherein the data file includes text in a format of
<state specification><property>=<item,item,item . . . >, wherein a state specification field identifies the application state, the item field identifies the menu/toolbar entities which are modified, and the property field indicates whether the application state enables or disables the menu/toolbar entities.

49. The computer readable medium of claim 48, wherein the menu/toolbar entities include menu items and toolbar items.

50. The computer readable medium of claim 37, wherein the application states include a plurality of states and a plurality of state parts, and wherein each application can, at any given time, be in one of the plurality of states and in zero or more of the plurality of state parts.

51. A computer readable medium, having stored thereon, computer executable process steps operative to control a computer to generate menu/toolbar entities on a graphical user interface, comprising:
providing an application which can be displayed in a frame of a graphical user interface, the application having a corresponding set of menu/toolbar entities, the application being in one of a respective plurality of application states at any given time, information indicative of an application state characteristic for each application state of the application being contained in a data file, each application state characteristic defining a display characteristic of at least one of the set of menu/toolbar entities; and
generating a displayed set of menu/toolbar entities on the graphical user interface based upon the application state characteristic of a current one of the application states of the application.

52. A computer readable medium, having stored thereon, computer executable process steps operative to control a computer to generate menu/toolbar entities on a graphical user interface having a parent frame for displaying menu/toolbar items and a plurality of child frames, comprising the steps of:
providing a set of applications which can be displayed in the plurality of child frames, each application having a corresponding set of menu/toolbar entities, each application being in one of a respective plurality of application states at any given time, information indicative of an application state characteristic for each application state of each application being contained in a data file, each application state characteristic defining a display characteristic of at least one of the set of menu/toolbar entities; and
generating a displayed set of menu/toolbar entities on the graphical user interface based upon the application state characteristic of a current one of the application states of a currently focused one of the applications.

53. The computer readable medium of claim 52, wherein each application has a corresponding data file.

54. The computer readable medium of claim 51, wherein the display characteristic is one of an enabled menu/toolbar entity and a disabled menu/toolbar entity.

55. The computer readable medium of claim 54, wherein the data file includes text in a format of
<state specification><property>=<item,item,item . . . >, wherein a state specification field identifies the application state, the item field identifies the menu/toolbar entities which are modified, and the property field indicates whether the application state enables or disables the menu/toolbar entities.

56. The computer readable medium of claim 55, wherein the menu/toolbar entities include menu items and toolbar items.

57. The computer readable medium of claim 1, wherein the application states include a plurality of states and a plurality of state parts, and wherein the application can, at any given time, be in one of the plurality of states and in zero or more of the plurality of state parts.

58. A computer readable medium, having stored thereon, computer executable process steps, operative to control a computer to configure a plurality of menu/toolbar entities for an application, comprising:
selecting a plurality of states for an application, the application having associated therewith a plurality of menu/toolbar entities for displaying on a graphical user interface;
selecting a state characteristic for each state, the state characteristic defining characteristics of a plurality of menu/toolbar entities of the application based on the state, information defining the state characteristics being stored in a data file;
entering the application into a current one of the plurality of states; and
applying the state characteristic of the current state of the application to the plurality of menu/toolbar entities displayed on a graphical user interface, based upon the information in the data file.

59. A computer readable medium, having stored thereon, computer executable process steps, operative to control a computer to configure a plurality of menu/toolbar entities for an application, comprising:
selecting a first plurality of states for an application, the application having associated therewith a plurality of menu/toolbar entities for displaying on a graphical user interface;
selecting a second plurality of state parts, each state part being associated with one or more of the plurality of states.
selecting a state characteristic for each state and each state part, the state characteristic defining characteristics of a plurality of menu/toolbar entities of the application based on the state, information defining the state characteristics being stored in a data file;
entering the application into a current one of the plurality of states;
applying the state characteristic of the current state of the application to the plurality of menu/toolbar entities displayed on a graphical user interface, based upon the information in the data file;
entering the application into a current of the plurality of state parts for the current state;
applying the state characteristic of the current state part to the plurality of menu/toolbar entities displayed on a graphical user interface, based upon the information in the data file.

60. The computer readable medium as recited in claim 58 wherein the state further comprises a sub-state.

61. The computer readable medium as recited in claim 58 wherein the state further comprises a state part.

62. The computer readable medium as recited in claim 58 wherein the state is a base state.

63. The computer readable medium as recited in claim 59 wherein the state is a base state.

64. The computer readable medium as recited in claim 58 wherein the step of entering further comprises pushing the state on a stack.

65. The computer readable medium as recited in claim 60 wherein the step of entering further comprises pushing the sub-state on a stack.

66. The computer readable medium as recited in claim 61 wherein the step of entering further comprises pushing the state part on a stack.

67. The computer readable medium of claim 59, further comprising entering a new current one of the plurality of states;
deapplying the state characteristics of the current state and current state part; and
applying the state characteristic of the new current state of the application to the plurality of menu/toolbar entities displayed on the graphical user interface, based upon the information in the data file.

68. The computer readable medium of claim 67, where in the step of deapplying further comprises popping the current state and current state part from a stack, and wherein the step of applying further comprises pushing the new current state on the stack.

69. A system for generating menu/toolbar entities on a graphical user interface having a parent frame for displaying menu/toolbar items and a plurality of child frames, comprising:
a display device for displaying the graphical user interface;
a computer processor coupled to a memory;
a set of applications stored in the memory which can be displayed in the plurality of child frames on the display device, each application having a corresponding set of menu/toolbar entities, information indicative of a policy for each menu/toolbar entity of each application being contained in a data file, each application being in one of a respective plurality of application states at any given time, information indicative of an application state characteristic for each application state of each application being contained in the data file, each application state characteristic defining a display characteristic of at least one of the set of menu/toolbar entities; and
the computer processor generating a displayed set of menu/toolbar entities on the graphical user interface based upon the policies of the menu/toolbar entities for a currently focused one of the applications and upon the application state characteristic of a current one of the application states of the currently focused application.

70. The system of claim 69, wherein each application has a corresponding data file.

71. The system of claim 70, wherein the policy for each menu/tool bar entity is selected from a set of policies and placing information indicative of the policy into the data file, the set of policies including a replace policy and an append policy, each menu/toolbar entity having an identifier, and wherein
the computer processor, for each menu/toolbar entity in an application gaining focus, compares the identifier of the menu/toolbar entity to the identifier of each menu/toolbar entity in a current set of menu/toolbar entities, and, upon finding a match:
replaces the matched menu/toolbar entity of the current set of menu/toolbar entities with the matched menu/toolbar entity of the application gaining focus in the displayed set of menu/toolbar entities when the policy of the matched menu/toolbar entity of the application gaining focus is the replace policy; and
adds the matched menu/toolbar entity of the application gaining focus to the displayed set of menu/toolbar entities when the policy of the matched menu/toolbar entity of the application gaining focus is the append policy.

72. The system of claim 69, wherein the set of menu/toolbar entities includes a toolbar having a set of toolbar items, and a menu bar having a set of menus, each menu having a corresponding set of menu items, and wherein the menu bar, the toolbar, each menu, each menu item, and each toolbar item each have a respective policy.

73. The system of claim 72, wherein the respective policy for each menu is selected from a set of policies and placing information indicative of the policy into the data file, the set of policies including a merge policy, a replace policy and an append policy, each menu having an identifier, and wherein
the computer processor, for each menu in an application gaining focus, compares the identifier of the menu bar to the identifier of each menu in a current set of menu/toolbar entities, and, upon finding a match:
replaces the matched menu of the current set of menu/toolbar entities with the matched menu of the application gaining focus in the displayed set of menu/toolbar entities when the policy of the matched menu of the application gaining focus is the replace policy;
adds the matched menu of the application gaining focus to the displayed set of menu/toolbar entities when the policy of the matched menu of the application gaining focus is the append policy; and
generates the displayed set of menu/toolbar entities on the graphical user interface on the display device based upon the policies of the menu items of the matched menu of the application gaining focus, when the policy of the matched menu of the application gaining focus is the merge policy.

74. The system of claim 73, wherein the respective policy for each tool bar is selected from a set of policies and placing information indicative of the policy into the data file, the set of policies including a merge policy, a replace policy and an append policy, each tool bar having an identifier, and wherein
the computer processor, for each tool bar in an application gaining focus, compares the identifier of the menu bar to the identifier of each tool bar in a current set of menu/toolbar entities, and, upon finding a match:
replaces the matched tool bar of the current set of menu/toolbar entities with the matched tool bar of the application gaining focus in the displayed set of menu/toolbar entities when the policy of the matched tool bar of the application gaining focus is the replace policy;
adds the matched tool bar of the application gaining focus to the displayed set of menu/toolbar entities when the policy of the matched tool bar of the application gaining focus is the append policy; and
generates the displayed set of menu/toolbar entities on the graphical user interface on the display device based upon the policies of the tool bar items of the matched tool bar of the application gaining focus, when the policy of the matched tool bar of the application gaining focus is the merge policy.

75. The system of claim 74, wherein, when the matched menu bar has the merge policy, a respective policy for each menu item is selected from a set of policies and information indicative of the policy placed into the data file, the set of policies including a replace policy and an append policy, each menu item having an identifier, and wherein
the computer processor, for each menu item in an application gaining focus, compares the identifier of the menu item to the identifier of each menu bar in a current set of menu/toolbar entities, and, upon finding a match:
replaces the matched menu item of the current set of menu/toolbar entities with the matched menu item of the application gaining focus in the displayed set of menu/toolbar entities when the policy of the matched menu item of the application gaining focus is the replace policy;
adds the matched menu item of the application gaining focus to the displayed set of menu/toolbar entities when the policy of the matched menu item of the application gaining focus is the append policy.

76. The system of claim 75, wherein, when the matched tool bar has the merge policy, a respective policy is selected for each tool bar item from a set of policies and information indicative of the policy is placed into the data file, the set of policies including a replace policy and an append policy, each tool bar item having an identifier, and wherein
the computer processor, for each tool bar item in an application gaining focus, compares the identifier of the tool bar item to the identifier of each tool bar item in a current set of menu/toolbar entities, and, upon finding a match:
replaces the matched tool bar item of the current set of menu/toolbar entities with the matched tool bar item of the application gaining focus in the displayed set of menu/toolbar entities when the policy of the matched tool bar item of the application gaining focus is the replace policy;
adds the matched tool bar item of the application gaining focus to the displayed set of menu/toolbar entities when the policy of the matched tool bar item of the application gaining focus is the append policy.

77. A system for generating menu/toolbar entities on a graphical user interface, comprising:
a display device for displaying the graphical user interface;
a computer processor coupled to a memory;
an application which can be displayed in a frame of a graphical user interface, the application having a corresponding set of menu/toolbar entities, the application being in one of a respective plurality of application states at any given time, information indicative of an application state characteristic for each application state of the application being contained in a data file, each application state characteristic defining a display characteristic of at least one of the set of menu/toolbar entities;
the computer processor generating a displayed set of menu/toolbar entities on the graphical user interface on the display device based upon the application state characteristic of a current one of the application states of the application.

78. A system for generating menu/toolbar entities on a graphical user interface having a parent frame for displaying menu/toolbar items and a plurality of child frames, comprising:
a display device for displaying the graphical user interface;
a computer processor coupled to a memory;
a set of applications which can be displayed in the plurality of child frames, each application having a corresponding set of menu/toolbar entities, each application being in one of a respective plurality of application states at any given time, information indicative of an application state characteristic for each application state of each application being contained in a data file, each application state characteristic defining a display characteristic of at least one of the set of menu/toolbar entities; and
the computer processor generating a displayed set of menu/toolbar entities on the graphical user interface based upon the application state characteristic of a current one of the application states of a currently focused one of the applications.

79. A method for altering an input entity on a graphical user interface, comprising
providing, in a data file, information indicative of a corresponding set of input entities for each of a plurality of system conditions; and
generating a displayed set of input entities based upon a current system condition.

80. The method of claim 79, wherein the plurality of system conditions include an application gaining focus.

81. The method of claim 79, wherein the plurality of system conditions include an application state.

82. The method of claim 79, wherein the plurality of input entities include menu/toolbar entities.

83. The method of claim 79, wherein the plurality of input entities include checkbox elements.

84. A method for generating menu/toolbar entities on a graphical user interface, comprising the steps of:
providing an application which can be displayed in a frame of a graphical user interface, the application having a corresponding set of input entities, the application being in one of a respective plurality of application states at any given time, information indicative of an application state characteristic for each application state of the application being contained in a data file, each application state characteristic defining a display characteristic of at least one of the set of input entities; and
generating a displayed set of input entities on the graphical user interface based upon the application state characteristic of a current one of the application states of the application.

85. The method of claim 84, wherein the set of input entities include menu/toolbar entities.

86. The method of claim 79, wherein the set of input entities include checkbox elements.

87. A method for generating menu/toolbar entities on a graphical user interface having a parent frame for displaying menu/toolbar items and a plurality of child frames, comprising the steps of:
providing a set of applications which can be displayed in the plurality of child frames, each application having a corresponding set of input entities, each application being in one of a respective plurality of application states at any given time, information indicative of an application state characteristic for each application state of each application being contained in a data file, each application state characteristic defining a display characteristic of at least one of the set of input entities; and
generating a displayed set of input entities on the graphical user interface based upon the application state characteristic of a current one of the application states of a currently focused one of the applications.

88. The method of claim 87, wherein each application has a corresponding data file.

89. The method of claim 87, wherein the set of input entities include checkbox elements.

90. The method of claim 88, wherein the data file includes text in a format of
<state specification><property>=<item,item,item . . . >, wherein a state specification field identifies the application state, the item field identifies the menu/toolbar entities which are modified, and the property field indicates whether the application state enables or disables the input entities.

91. A method of configuring a plurality of input entities for an application comprising the steps of:
selecting a plurality of states for an application, the application having associated therewith a plurality of input entities for displaying on a graphical user interface;
selecting a state characteristic for each state, the state characteristic defining characteristics of a plurality of input entities of the application based on the state, information defining the state characteristics being stored in a data file;
entering the application into a current one of the plurality of states; and
applying the state characteristic of the current state of the application to the plurality of input entities displayed on a graphical user interface, based upon the information in the data file.

92. A method of configuring a plurality of input entities for an application comprising the steps of:
selecting a first plurality of states for an application, the application having associated therewith a plurality of input entities for displaying on a graphical user interface;
selecting a second plurality of state parts, each state part being associated with one or more of the plurality of states.
selecting a state characteristic for each state and each state part, the state characteristic defining characteristics of a plurality of input entities of the application based on the state, information defining the state characteristics being stored in a data file;
entering the application into a current one of the plurality of states;
applying the state characteristic of the current state of the application to the plurality of input entities displayed on a graphical user interface, based upon the information in the data file;
entering the application into a current one of the plurality of state parts for the current state;
applying the state characteristic of the current state part to the plurality of input entities displayed on a graphical user interface, based upon the information in the data file.
